(19) United States
(12) Patent Application Publication
(10) Pub. No.: US 2004/0246528 A1
(43) Pub. Date: Dec. 9, 2004

(54) Image process apparatus

(75) Inventors: Koji Washio, Tokyo (JP); Kousuke Touura, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Business Technologies, Inc., Tokyo (JP)

(21) Appl. No.: 10/777,540

(22) Filed: Feb. 11, 2004

(30) Foreign Application Priority Data
Jun. 6, 2003 (JP) 2003-161772

(51) Int. Cl. H04N 1/405; H04N 1/409

(52) U.S. Cl. 358/3.06; 358/3.26

(57) ABSTRACT

An image process apparatus has: a halftone process section for performing a halftone process on image data input from an image reading device which reads a document image; and a block average process section, wherein the halftone process section generates a continuous pattern in a fashion of a line structure by performing a dither process on the image data input, and the block average process section divides the image data input into a plurality of blocks whose centers approximately correspond to a centerline of the line structure generated by the halftone process section, calculates an average value of pixel values in each block, and replaces the pixel values in each block with the average value calculated.

### BACKGROUND OF THE INVENTION

1. Field of the Invention

The present invention relates to an image process apparatus that applies an image process such as a halftone process or the like on image data read by an image reading apparatus.

2. Description of Related Art

When a halftone process such as a dither process or the like is applied on image data obtained by reading a document of printed material with the use of an image reading apparatus such as an image scanner or the like, moiré may occur due to interference between a cycle structure made of a halftone dots structure in the document and a cycle structure made of a pattern generated from the halftone process. In order to eliminate moiré, it is effective to break the cycle structure at the document side, and as its method, a moving average process with a mean filter has been known so far.

However, the mean filter flattens detail of an image as well as the cycle structure made of the halftone dots structure in the document. Thereby, it decreases sharpness of the image and the image gets deteriorated.

Given this factor, in order to solve this problem, a method of selectively changing intensity, size or the like of the mean filter according to local feature in the document or in a block within the document has been used (for example, see Japanese Patent Application Publication (Unexamined) Tokukai-Hei 5-236360, Tokukai-Hei 5-48894 and Tokukai 2000-10184).

However, in the above-mentioned patent documents, it is necessary to analyze the feature in the image or in the block within the document, and thereby the process thereof is complicated. Further, in the mean filter process, it is necessary to have a considerably large size filter in order to cut off a cycle structure of a dot pattern in the document. However, the mean filter process with such a large size filter cuts off not only a cycle structure of a dot pattern but also a high frequency detail in the document. Thereby, the mean filter processing makes the image quality poor.

### SUMMARY OF THE INVENTION

An object of the present invention is to effectively eliminate moiré which occurs when a halftone process is applied on image data obtained by reading a document, without high frequency detail deteriorated.

In order to solve the above-mentioned problem, in accordance with a first aspect of the present invention, an image process apparatus comprises: a halftone process section for performing a halftone process on image data input from an image reading device which reads a document image; and a block average process section, wherein the halftone process section generates a continuous pattern in a fashion of a line structure by performing a dither process on the image data input, and the block average process section divides the image data input into a plurality of blocks whose centers approximately correspond to a centerline of the line structure generated by the halftone process section, calculates an average value of pixel values in each block, and replaces the pixel values in each block with the average value calculated.

According to the apparatus of the first aspect of the present invention, the input image data is divided into a plurality of blocks whose centers approximately correspond to a centerline of the line structure generated by the halftone process section, an average value of pixel values in each block is calculated, and the pixel values in each block are replaced with the calculated average value. Thereby, it is possible to effectively eliminate moiré without high frequency detail deteriorated.

Here, regarding the shape of the continuous pattern in a line-structured fashion or the like generated by the dither process, for example, it is written in “Postscript Screening” (by Peter Fink, Publisher: Adobe Press). Needless to say, a pattern in a line-structured fashion is fairly generally used in the dither method.

Preferably, in the apparatus of the first aspect of the present invention, the block average process section calculates a weighting average value according to the pixel values in each block and pixel values around each block, and replaces the pixel values in each block with the weighting average value calculated.

According to the above-mentioned apparatus, a weighting average value is calculated with the use of the pixel values in each block and pixel values around each block, and the pixel values in each block are replaced with the calculated weighting average value. Therefore, it is possible to effectively eliminate moiré, and when the pixel number per one block is small, it is possible to eliminate noise which could not be eliminated by averaging the pixel values in each block only. Further, by increasing weight on center pixels in a block, it is possible to maintain sharpness.

Preferably, in the apparatus of the first aspect of the present invention, the block average process section calculates the average value according to the pixel values in each block only, and replaces the pixel values in each block with the average value calculated.

According to the above-mentioned apparatus, an average value is calculated with the use of the pixel values in each block only, and the pixel values in each pixel are replaced with the calculated average value. Therefore, it is possible to effectively eliminate moiré with sharpness maintained.

In accordance with a second aspect of the present invention, an image process apparatus comprises: a halftone process section for performing a halftone process on image data input from an image reading device which reads a document image; and a block average process section, wherein the halftone process section generates a continuous pattern in a fashion of a line structure by performing a dither process on the image data input, and the block average process section divides the image data input into a plurality of blocks so as to make a cycle structure of the plurality of blocks correspond to a cycle structure of the pattern generated by the halftone process section, calculates an average value of pixel values in each block, and replaces the pixel values in each block with the average value calculated.

According to the apparatus of the second aspect of the present invention, the input image data is divided into a plurality of blocks so as to make a cycle structure of the plurality of blocks correspond to a cycle structure of the pattern generated by the halftone process section, an average value of pixel values in each block is calculated, and the pixel values in each block are replaced with the calculated average value. Thereby, it is possible to effectively eliminate moiré without high frequency detail deteriorated.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a functional structure of an image formation apparatus 1 according to the present invention,

FIG. 2A is a view showing one example of a dither pattern generated by a halftone process unit 24 in FIG. 1,

FIG. 2B is a view showing a cycle structure of the dither pattern of FIG. 2A,

FIG. 3 is a view showing an example of block division when a block average process unit 22 of FIG. 1 block-averages the dither pattern shown in FIG. 2A,

FIG. 4 is a view showing a circuit example of the block average process unit 22 of FIG. 1,

FIG. 5 is a view showing another circuit example of the block average process unit 22 of FIG. 1 when a weighting average value is obtained by using pixels within a block and pixels around the block,

FIG. 6 is a view showing one example of γ correction curve used in γ correction unit 23 of FIG. 1,

FIG. 7 is a block diagram showing an internal structure of the halftone process unit 24 of FIG. 1,

FIG. 8A is a view showing one example of image data before a process for eliminating a cycle structure at the document side is applied thereon, FIG. 8B is a view showing a cycle structure of the image data after a moving average process with three-pixel size is applied on the image data having the cycle structure of FIG. 8A, FIG. 8C is a view showing a cycle structure of the image data after the image data having the cycle structure of FIG. 8A is block-averaged at a three-pixel unit,

FIG. 9A is a view showing image data D5 obtained by applying a dither process on image data D1 in which image signal values monotonously increase without using block averaging, FIG. 9B is a view showing image data D5 obtained by applying the dither process on image data D1 in which image signal values monotonously decrease without using block averaging, FIG. 9C is a view showing image data D5 obtained by applying the dither process on image data D3 which is obtained by block-averaging at a three-pixel cycle, image data D1 in which image signal values monotonously increase, FIG. 9D is a view showing image data D5 obtained by performing the dither process on image data D3 which is obtained by block-averaging at a three-pixel cycle, image data D1 in which image signal values monotonously decrease, and

FIG. 10 is a block diagram showing a functional structure of an image formation apparatus 2, which is a color photocopier.

### EMBODIMENTS OF THE INVENTION

Hereinafter, with reference to figures, an embodiment of the present invention will be described in detail.

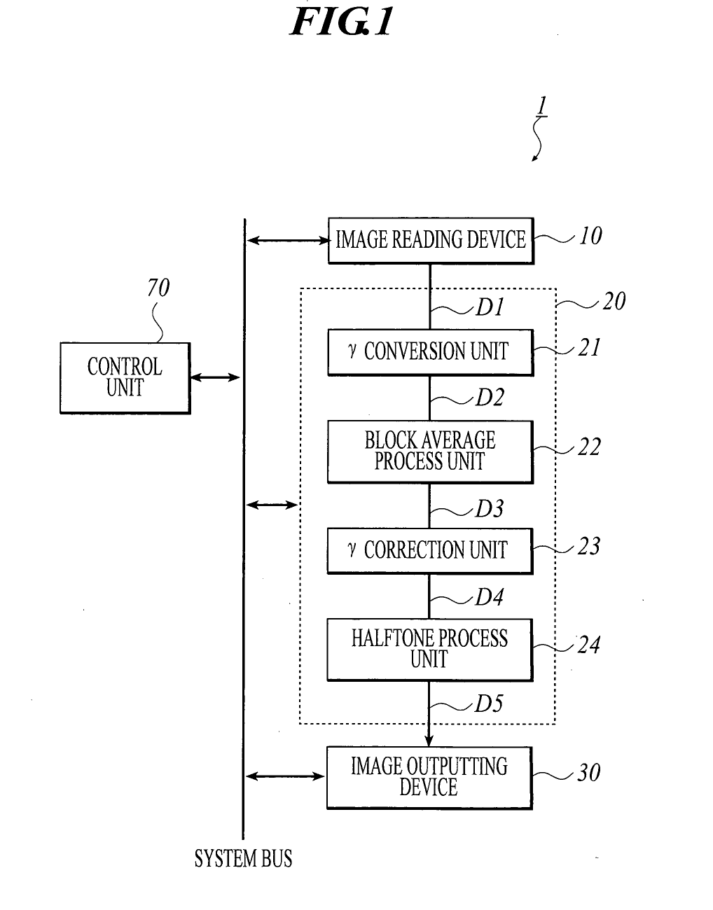

FIG. 1 shows an example of a functional structure of an image formation apparatus 1 according to the present invention. The image formation apparatus 1 is a monochrome photocopier, and as shown in FIG. 1, the image formation apparatus 1 comprises an image reading device 10, an image process device 20, an image outputting device 30 and the like. Each component is operated under integral control by a control unit 70 comprising a CPU and the like connected thereto.

The image reading device 10 comprises a light source, a CCD (Charge Coupled Device), an A/D converter and the like. The image reading device 10 reads an image of a document by imaging and photoelectric-converting the reflected light of light which is illuminated from the light source and scans the document, and A/D-converting the read image into image data D1 to be output to the image process device 20. Here, the image is not limited to image data such as graphics, photographs and the like, but it includes text data such as letters, marks and the like, and so on.

The image process device 20 applies various types of image processes on the image data D1 to be output as image data D5 to the image outputting device 30. In other words, the image data D1 input to the image process device 20 is applied γ conversion on by a γ conversion unit 21, and the converted image data D2 is averaged by a block average process unit 22, the averaged image data D3 is γ-corrected by a γ correction unit 23, the corrected image data D4 is processed by a halftone process unit 24, and the processed image data D5 is output to the image outputting device 30.

The γ conversion unit 21 applies γ correction on the image data D1 read by the image reading device 10 for converting from brightness linear into density linear, and outputs the converted image data D2 to the block average process unit 22.

The block average process unit 22 applies the block average process on the image data D2 in synchronization with the halftone process unit 24, which will be described later, in order to eliminate a cycle structure at the document side included in the image data D1 read by the image reading device 10.

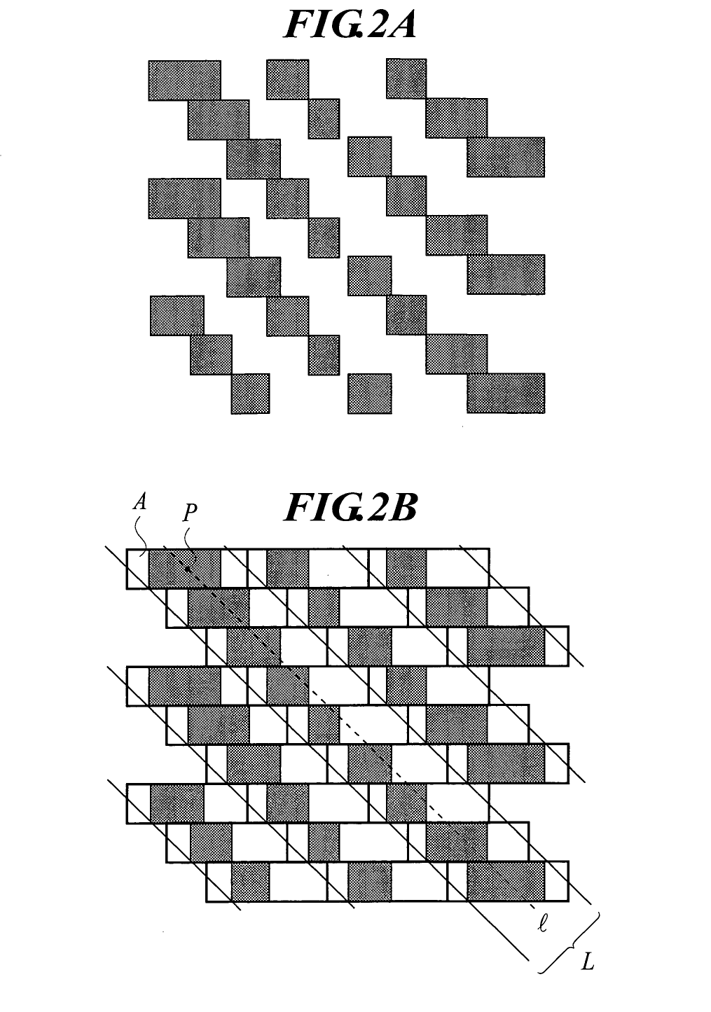

Hereinafter, description regarding the block average process will be made in detail. FIG. 2A shows an example of a dither pattern generated by the halftone process unit 24. In the halftone process unit 24, a continuous pattern in a line-structured fashion is generated according to the ordered dither method. The dither pattern in FIG. 2A has a pattern in a fashion of a diagonal line structure L as shown in FIG. 2B. The pattern in the fashion of the diagonal line structure L is composed of a cycle structure A determined by threshold values (hereinafter, referred to as dither matrix) located in a matrix fashion, the cycle structure A to be used in the halftone process. The cycle structure A is a cycle structure of the dither pattern in FIG. 2A, and will be hereinafter described with a three-pixel cycle as an example.

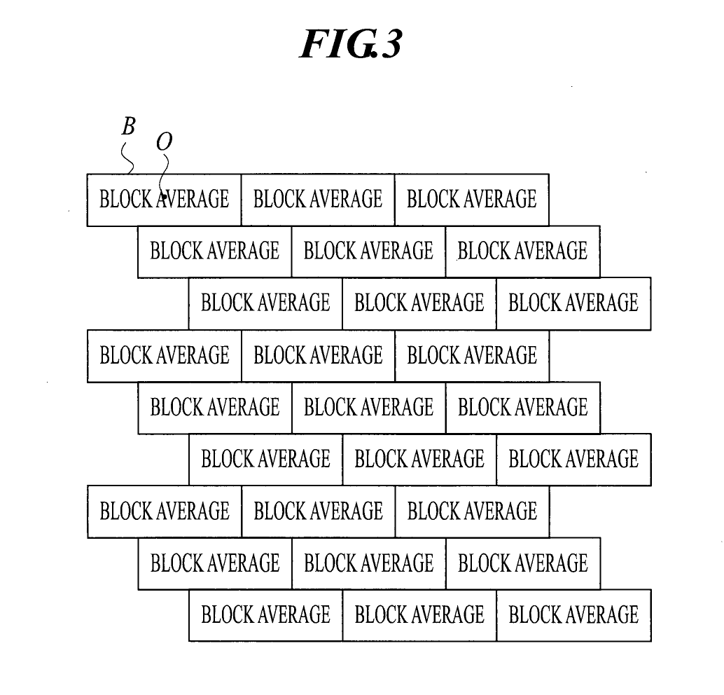

Here, when a cycle structure at the document side included in the image data D1 read by the image reading device 10 is different from a cycle structure of the dither pattern, for example, in the case of being a two-pixel cycle, moiré occurs. Therefore, in the block average process unit 22, as shown in FIG. 3, the block average process by which the image data D2 is blocked in order to have the same cycle structure as the dither pattern is performed, an average value (weighting average value) is calculated with the use of pixels in the block or both the pixels in the block and around the block, and the pixels in the block are replaced with the calculated average value (weighting average value). When the image data D2 is to be blocked, blocking is performed so that the centers O of each block approximately correspond to the centerline of the line structure of the dither pattern. For example, when a dither pattern in a fashion of the line structure L shown in FIG. 2 is to be generated in the halftone process unit 24, which will be described later, the image data D2 is blocked as shown in FIG. 3 in the block average process unit 22. At this time, blocking is performed so that a position of the center O of a block B shown in FIG. 3 approximately corresponds to a point P located on the centerline 1 of the line structure L of the dither pattern shown in FIG. 2B. Here, to approximately correspond means that an error therebetween does not exceed a half size of the block.

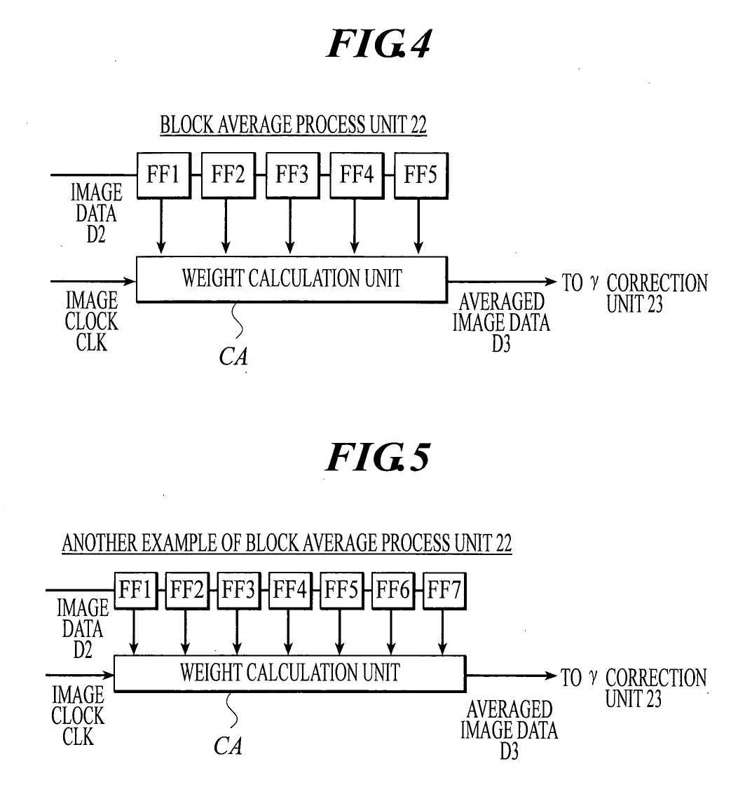

FIG. 4 shows a circuit example of the block average process unit 22. The circuit example is to block-average the image data D2 at a three-pixel cycle. FF1 to FF5 are shift registers composed of flip flops, and one-pixel portion of the image data D2 is transmitted one by one through the FF1 to FF5 according to a pixel clock CLK from a control unit 70.

A weight calculation unit CA calculates OUT1 to OUT3 as shown below with the use of values (image signal values) of the FF1 to FF5 for obtaining the weighing average values per each pixel clock CLK.

OUT1=(p1×FF1+p2×FF2+p3×FF3)/(p1+p2+p3)

OUT2=(p1×FF2+p2×FF3+p3×FF4)/(p1+p2+p3)

OUT3=(p1×FF3+p2×FF4+p3×FF5)/(p1+p2+p3)

Here, p1, p2 and p3 are coefficients for weighting, and integer number is used for them. For example, for calculating simple averages, an equation p1=p2=p3=1 should be satisfied, and for increasing weight on center pixels, equations p1=1, p2=2 and p3=1 should be satisfied. It is possible to maintain sharpness by obtaining average values with the use of pixels in the block only. Furthermore, by increasing weight on values of center pixels, it is possible to maintain sharpness even more.

When the weighting average values of the OUT1 to OUT3 are obtained, a selector in the weight calculation unit CA generates a select signal, and based on the select signal, any one of the values of OUT1, OUT2 and OUT3 is selected to be output. In the present embodiment, the selector in the weight calculation unit CA selects the value of OUT1 when the select signal is 0, the value of OUT2 when the select signal is 1, and the value of OUT 3 when the select signal is 2.

The select signal is obtained from an equation below according to a location of a pixel of interest in a main scanning direction and in a sub scanning direction:

select signal=(location in main scanning direction−location in sub scanning direction % 3) % 3

Here, the operator “%” means calculating a remainder of division of a value at its right side into a value at its left side. The location in the main scanning direction and the location in the sub scanning direction can be obtained by counting the pixel clock CLK. For example, when image data having width of 7000 pixels in the main scanning direction is to be processed, if pixel clock number is defined as a counted value by counting the pixel clock CLK from the beginning of the process, they can be obtained from equations below:

location in main scanning direction=pixel clock number % 7000

location in sub scanning direction=pixel clock number/7000

Based on the generated select signal, by selecting any one of the values of OUT1, OUT2 and OUT3 to be output, the values of OUT1 to OUT3 are circularly selected (in the order of OUT1→OUT2→OUT3→OUT1→OUT2→OUT3→ . . . ) and output as the averaged image data D3.

From the above-described structure, as shown in FIG. 3, it is possible to achieve the block averaging in a diagonal line-structured fashion where a block is deviated as much as one pixel toward the right when we look at a block located one line below. Needless to say, by controlling a block so as to be deviated as much as ‘n’ pixels toward the right when we look at a block located ‘m’ lines below or the like, it is possible to easily achieve the adjustment of an angle of the diagonal line structure (‘m’ and ‘n’ are integer numbers). In this case, the select signal can be obtained by an equation below:

select signal=((location in main scanning direction−(location in sub scanning direction/m) % 3) % 3)×n

By performing this control in synchronization with designation of an angle by the halftone process unit 24, which will be described later, it is possible to perform the blocking similarly to a structure of the dither pattern generated by the halftone process unit 24.

Further, if weighting averaging is performed with the use of pixels not only in the block but also around the block, when the pixel number per one block is small, it is possible to eliminate moiré which could not be eliminated by averaging only the pixels within the block. Furthermore, by increasing weight on center pixels, it is possible to maintain sharpness.

FIG. 5 shows another example of the block average process unit 22. In a circuit shown in FIG. 5, when the image data D2 is block-averaged at a three-pixel cycle, the weight averaging is performed with the use of pixels in the block and around the block. As shown in FIG. 5, if the weight averaging is performed with the use of pixels around the block, the number of the flip flops should be increased (FF1 to FF7) and the equations of OUT1 to OUT3 should be modified as follows:

OUT1=(p1×FF1+p2×FF2+p3×FF3+p4×ff4+p5×FF5)/(p1+p2+p3+p4+p5)

OUT2=(p1×FF2+p2×FF3+p3×FF4+p4×ff5+p5×FF6)/(p1+p2+p3+p4+p5)

OUT3=(p1×FF3+p2×FF4+p3×FF5+p4×ff6+p5×FF7)/(p1+p2+p3+p4+p5)

Here, p1, p2, p3, p4 and p5 are coefficients for weighting, and integer number is used for them. For example, for calculating simple averages, an equation p1=p2=p3=p4=p5=1 should be satisfied, and for increasing weight on center pixels, equations p1=1, p2=2, p3=3, p4=2 and p5=1 should be satisfied.

After the block average process unit 22 applies the block averaging on the image data D2, the averaged image data D3 is output to the γ correction unit 23.

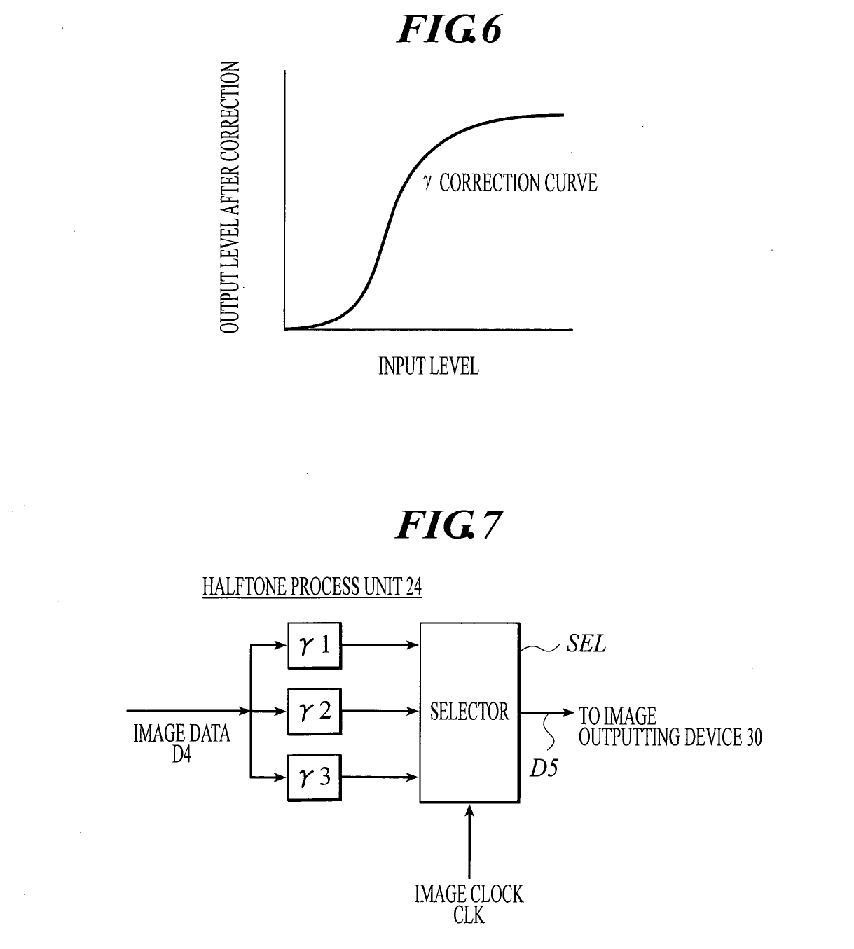

The γ correction unit 23 converts a level of the image data D3 with a predetermined γ correction curve as shown in FIG. 6, and corrects gradation characteristic of the image outputting device 30. The image data D4 having had gradation characteristic corrected by γ correction unit 23 is output to the halftone process unit 24.

The halftone process unit 24 performs a dither process according to the ordered dither method, and binalizes an image signal value of each pixel of the image data D4 in comparison with a threshold value according to the pixel location. FIG. 7 shows an example of an internal structure of the halftone process unit 24. Comparison operation units γ1, γ2 and γ3 and a selector SEL shown in FIG. 7 perform the binalization process by comparing the image signal value of each pixel of the image data D4 with the threshold value of the 3×1 dither matrix according to each pixel location. Each pixel of the image data D4 is input to the comparison operation units γ1, γ2 and γ3. The comparison operation units γ1, γ2 and γ3 have threshold values in advance, and the comparison operation units γ1, γ2 and γ3 performs comparison calculation between the threshold values and input image signal values, and outputs the calculation result to the selector SEL.

Operation of the selector SEL is approximately the same as the above-described selector in the weight calculation unit CA of the block average process unit 22. In other words, the selector SEL generates a select signal, and based on the select signal, the selector SEL selects any one of output values from the comparison operation units γ1, γ2 and γ3 to be output. In this example, the selector SEL selects γ1 when the select signal is 0, selects γ2 when the select signal is 1, and selects γ3 when the select signal is 2.

The select signal can be obtained from an equation below according to a location of a pixel of interest in a main scanning direction and a location of the pixel of interest in a sub scanning direction:

select signal=(location in main scanning direction−location in sub scanning direction % 3) % 3

Here, the operator % means calculating a remainder of division of a value at its right side into a value at its left side. The location in the main scanning direction and the location in the sub scanning direction can be obtained by counting the pixel clock CLK. For example, when image data having width of 7000 pixels in the main scanning direction is to be processed, if pixel clock number is defined as a counted value by counting the pixel clock CLK from the beginning of the process, they can be obtained from equations below:

location in main scanning direction=pixel clock number % 7000

location in sub scanning direction=pixel clock number/7000

Further, needless to say, designation of an angle has flexibility as well as it is described in the block average unit 22.

The image data D5 output from the selector SEL is output as a dither pattern in a diagonal line-structured fashion, as well as the case of the averaging.

Here, the above-described block average process unit 22 performs blocking of image signal values of each pixel of the image data D2 so as to generate approximately the same cycle structure as the dither pattern by having a structure according to the structure of the comparison operation unit used in the halftone process unit 24 and having control according to the control of the angle of the dither pattern in a diagonal line-structured fashion to be generated. At this time, the centers O of each block approximately correspond to the centerline of the line structure of the dither pattern.

The image data D5 on which dither process is applied by the halftone process unit 24 is output to the image outputting device 30.

The image outputting device 30 performs pulse-width modulation on the image data output from the selector SEL in the halftone process unit 24 and sends it to a laser drive circuit for emitting laser. The laser light is scanned on a photo conductor drum which is charged in advance, and a latent image is formed. An image is formed from the latent image on the photo conductor drum with toner development, transferred to printing paper, and fixated with heat to be output.

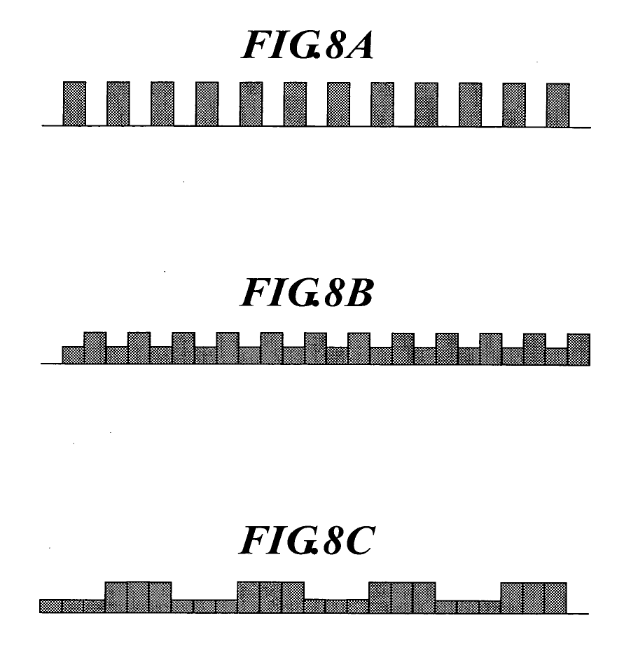

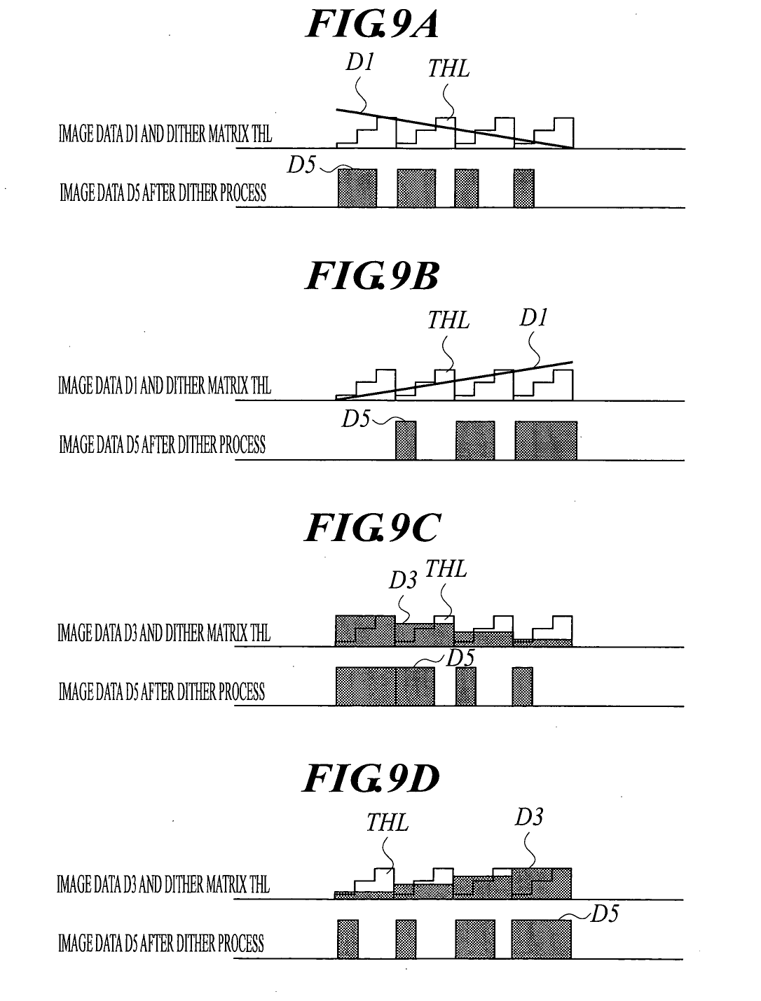

FIGS. 8A, 8B and 8C show explanatory drawings in order to compare image data D3a after the moving average process, which is conventionally used in order to eliminate a cycle structure at the document side, and the image data D3 after the block average process of the present invention. FIG. 8A is the image data D1 before the process, and here, it has a two-pixel cycle. When the moving average process at a three-pixel size is applied on this two-pixel cycled image data D1, a result shown in FIG. 8B can be obtained. However, in this case, a structure of the two-pixel cycle still remains. When the halftone process unit 24 applies the dither process which generates a dither pattern having a three-pixel cycle on this moving-average processed image data D3a, since the image data has unevenness within one cycle of the dither pattern, an image with some noisiness is obtained. Further, interference between the two-pixel cycle structure which cannot be eliminated and the cycle structure of the dither pattern causes moiré. Further, if the pixel number to be averaged is increased for eliminating the two-pixel cycle structure, the image loses its sharpness.

On the other hand, when the two-pixel cycled image data D1 shown in FIG. 8A is block-averaged with a three-pixel block unit which is the same as the dither pattern, as shown in FIG. 8C, the two-pixel cycle is completely eliminated and a cycle structure of a six-pixel cycle remains. One cycle of the six-pixel cycle has the same value per three pixels in one block. When the halftone process unit 24 applies the dither process, which generates a dither pattern at a three-pixel cycle, on the block-averaged image data D3, since a cycle structure of the blocks and that of the dither pattern correspond to each other, moiré does not occur.

Here, in the dither process, in order to express light and shade at a dither matrix size (here, it is three pixels) unit, if there is minute structure pictorially within the one unit, such structure cannot be expressed. On the other hand, in the dither process, in most cases, one cycle structure of the dither pattern is generated from one dither matrix. Accordingly, even if the block averaging process is performed on each dither pattern cycle, deterioration degree of the high frequency detail does not change.

FIGS. 9A, 9B, 9C and 9D show comparative drawings of image data D5 in the case of performing the block averaging process and the case of not performing the block averaging process. Here, all the dither matrix to be used for the dither process uses a three-pixel unit of dither matrix THL, in which threshold values increase as pixels are located toward the right. FIG. 9A shows the image data D5 obtained by applying the dither process on the image data D1 in which image signal values monotonously increase without the block averaging used, FIG. 9B shows image data D5 obtained by applying the dither process on the image data D1 in which image signal values monotonously decrease without the block averaging used, FIG. 9C shows image data D5 obtained by applying the dither process on image data D3 obtained by block-averaging at a three-pixel cycle, the image data D1 in which image signal values monotonously increase, and FIG. 9D shows image data D5 obtained by applying the dither process on image data D3 obtained by block-averaging at a three-pixel cycle, the image data D1 in which image signal values monotonously decrease.

When the image signal values either monotonously increase or monotonously decrease as much as a predetermined value, a result of the dither process is expected to be symmetrical. However, as shown in FIGS. 9A and 9B, it does not always becomes symmetrical. This is because the setting of dither threshold has a tendency of making a pixel toward the left more dense than a pixel toward the right. Such dither anisotropy sometimes deteriorates image quality of character images and the like.

Therefore, when the block averaging process is performed at each dither process unit, as shown in FIGS. 9C and 9D, it is possible to minimize image quality deterioration due to the dither anisotropy. Thereby, by performing the block averaging process at one unit of the dither process, that is, the same cycle structure as a structure of the dither pattern, it is possible to reconstruct gradation of the image accurately.

As described above, according to the image formation apparatus 1 regarding the present invention, by applying the block averaging process at the same cycle structure as the cycle structure of the dither pattern on the image data D1 read by the image reading device 10 in the image process device 20, it is possible to effectively eliminate moiré without the high frequency detail deteriorated needlessly. Further, it is possible to reconstruct gradation stably.

Here, the description in the above-described embodiment is one example of the image formation apparatus 1 in the present invention, and is not limited to the description above.

For example, in the above-described embodiment, the block average process performed in the main scanning direction is described. However, needless to say, a similar effect can be obtained by performing the block average process in the sub scanning direction. Further, it is also possible that, in combination with the conventional moving average process, the moving average process and the block average process are performed sequentially.

Further, in the above-described embodiment, described is the case that the block average process is performed at every three pixels in the case of the cycle structure at the document side being at a two-pixel cycle and the cycle structure of a dither pattern being at a three-pixel cycle, as an example. However, the size of the block complies with the dither pattern, and therefore the size is not limited to the description.

Further, in the above-described embodiment, a monochrome photocopier is described as an example. However, the present invention can be applied to a color photocopier as well.

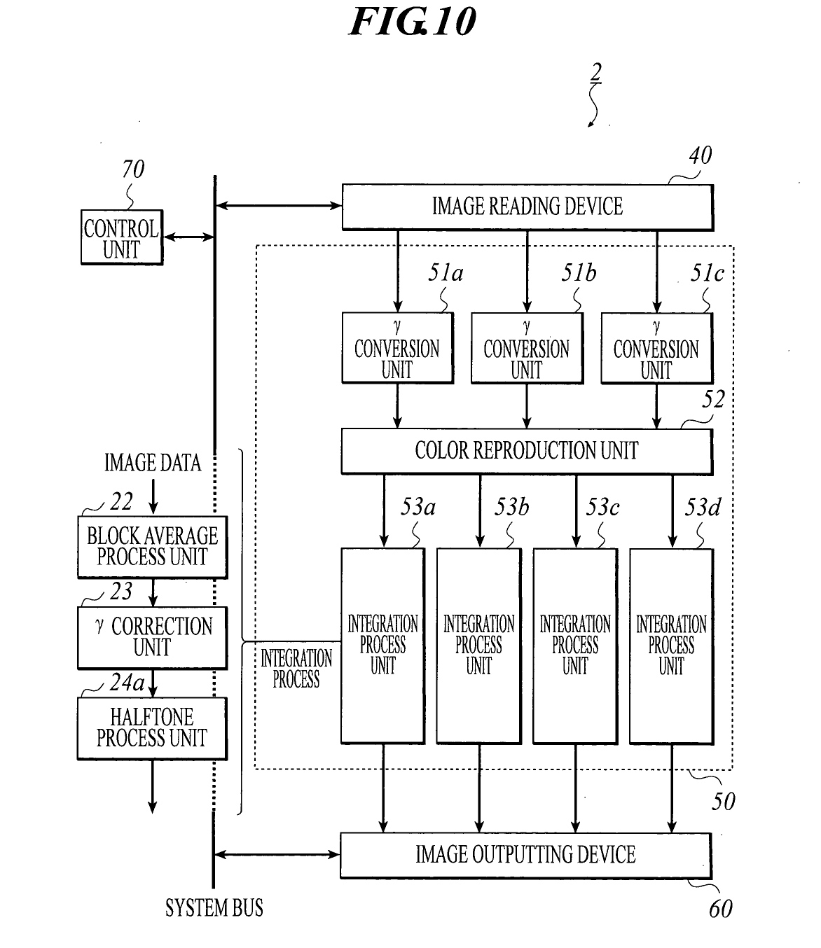

In FIG. 10, shown is a functional structure example of an image formation apparatus 2, which is a color photocopier. As shown in FIG. 10, the image formation apparatus 2 comprises an image reading device 40, an image process device 50 and an image output device 60. Each component is operated under integral control by a controller 70 comprising a CPU and the like connected thereto through a system bus.

The image reading device 40 comprises a light source, a CCD (Charge Coupled Device), an A/D converter and the like. The image reading device 40 reads an image of a document as R signal, G signal and B signal by imaging reflected light of scanning light on the document illuminated from the light source and photoelectrically converting it, and A/D converts the read image to be output to the image process device 50.

In the image process device, γ converting units 51a, 51b and 51c convert each image data, R, G and B input from the image reading device 40, from brightness linear into density linear, and a color reproduction unit 52 converts R, G, B image data into C, M, Y, K image data at each pixel. Integration process units 53a to 53d respectively perform the same process as the above-described average process unit 22, γ correction unit 23 and halftone process unit 24 on each color material of the C, M, Y, K image data and output the processed data to the image output device 60. Here, the halftone process unit 24a performs a multivalued dither process.

The image output device 60 is a color image output device, and outputs data by imaging, transferring and fixing based on the image data output from the image process device 50. As mentioned, also in a color photocopier, by applying the present invention thereto, it is possible to minimize deterioration of the high frequency detail needlessly, and eliminate moiré effectively.

Further, in the above-described embodiment, described is an image formation apparatus in an electrophotography system. However, the present invention is not limited to such an image formation apparatus. For example, an image formation apparatus can be applied to an inkjet system or the like.

And so forth, the structure detail and the operation detail of the image formation apparatus 1 can accordingly be changed without departing the gist of the present invention.

The entire disclosure of Japanese Patent Application No. Tokugan 2003-161772 filed on Jun. 6, 2003 including a specification, claims, drawings and summaries are incorporated herein by reference in their entirety.

What is claimed is:

1. An image process apparatus comprising:
a halftone process section for performing a halftone process on image data input from an image reading device which reads a document image; and
a block average process section,
wherein the halftone process section generates a continuous pattern in a fashion of a line structure by performing a dither process on the image data input, and
the block average process section divides the image data input into a plurality of blocks whose centers approximately correspond to a centerline of the line structure generated by the halftone process section, calculates an average value of pixel values in each block, and replaces the pixel values in each block with the average value calculated.

2. The apparatus of claim 1, wherein the block average process section calculates a weighting average value according to the pixel values in each block and pixel values around each block, and replaces the pixel values in each block with the weighting average value calculated.

3. The apparatus of claim 1, wherein the block average process section calculates the average value according to the pixel values in each block only, and replaces the pixel values in each block with the average value calculated.

4. An image process apparatus comprising:
a halftone process section for performing a halftone process on image data input from an image reading device which reads a document image; and
a block average process section,
wherein the halftone process section generates a continuous pattern in a fashion of a line structure by performing a dither process on the image data input, and
the block average process section divides the image data input into a plurality of blocks so as to make a cycle structure of the plurality of blocks correspond to a cycle structure of the pattern generated by the halftone process section, calculates an average value of pixel values in each block, and replaces the pixel values in each block with the average value calculated.
